(19) United States
(12) Patent Application Publication
(10) Pub. No.: US 2016/0280977 A1
(43) Pub. Date: Sep. 29, 2016

(54) Two-Part Urethane Adhesive

(71) Applicant: IFS Industries Inc., Reading, PA (US)

(72) Inventor: Zhijin Chen, Reading, PA (US)

(21) Appl. No.: 15/076,891

(22) Filed: Mar. 22, 2016

Related U.S. Application Data
(60) Provisional application No. 62/137,593, filed on Mar. 24, 2015.

(51) Int. Cl. C09J 175/06; B29C 65/48; B29C 65/52; C08G 18/66

(52) U.S. Cl. CPC C09J 175/06; C08G 18/664; B29C 65/483; B29C 65/522; B29C 65/524; B29C 65/52; B29K 2075/00

(57) ABSTRACT

Polyurethane adhesives are made from polyether and polyesters polyol condensations. The compositions are uniquely suited for ease of manufacture and improved adhesive characteristics particularly for high green strength and bonding low surface energy materials or substrates.

### CLAIM OF PRIORITY

This application claims priority to U.S. Provisional Application Ser. No. 62/137,593, filed on Mar. 24, 2015, the entire contents of which are hereby incorporated by reference.

### FIELD

A two part curable urethane adhesive material is suitable for article manufacture by forming an adhesive bond between varieties of substrates. The compositions relate to a two-part urethane adhesive having a part comprising an isocyanate (NCO) part also called a urethane pre-polymer and a part comprising a reactive polyol part. The polyols used in the NCO pre-polymer and in the reactive polyol polymer can be blended polyols. The adhesive is particularly suitable for use in applications in which initial high green strength is required for increased production or assembly productivity.

### BACKGROUND

In the manufacture of many multi-part work pieces, one substrate is bonded to a second substrate using a layer of an adhesive. Depending on the nature of the assembly process, the initial strength also known as “green” strength of the adhesive must be sufficient to maintain the mechanical stability of the work piece until the adhesive comes to a finally cured state where adhesive and cohesive bonding forces are adequate to maintain the work piece in a final configuration. In many applications the work piece is held in place on or with mechanical apparatus until the bond is fully cured resulting in significant adhesive and cohesive properties. However in many applications, the work piece is not mechanically secured during adhesive bond formation. This is particularly true in certain applications where two, three, four or more substrates are simultaneously or serially assembled with adhesive materials into an initial work piece structure before adhesive curing is complete. In the past many work pieces have been assembled using a variety of or combinations of different adhesive materials in multi-step processes required by the nature of the components and the conventional nature of work piece assembly. Many of these processes have required either multi-step construction processes or required multiple adhesive materials to fully obtain a final assembled work piece with a cured adhesive bond.

A substantial need exists in the art for an adhesive material that can be used to form an initial work piece with high green strength characteristics in a process with efficient and reduced processing steps to form a final work piece with high adhesive and cohesive bonds. A further need is seen for a reactive urethane adhesive in athletic shoes.

### BRIEF DISCLOSURE

One aspect is an NCO prepolymer.

A second aspect is a reactive polyol.

A third aspect is a two part adhesive of the NCO prepolymer and the reactive polyol part combined with optional adhesive components.

A fourth aspect relates to an article and its adhesive manufacturing processes.

A fifth aspect relates to an article such as a shoe and its manufacture.

Either NCO prepolymer or the reactive polyol can be a blend of a polyether polyol and a polyester polyol, the polyester can be a poly-alkylene oxide polymer. The polyester can be aromatic, aliphatic or a combination of aliphatic and aromatic components.

An embodiment is a work piece in which the bonded substrates are similar, and in another embodiment the bonded substrates can be made of different materials. Further embodiments of the substrates are made from polymeric materials with reduced or low surface energies.

The two part adhesives are preformed from manufacturing side before its application.

Another embodiment is a method of manufacture employing the adhesive compositions. The method involves application of the two part adhesive to one or more substrates, followed by contact of the adhesive composition with a second substrate within 0.1 to 10 seconds after application of the adhesive composition to the substrate, wherein the contacting results in an adhesive bond between the substrates.

Yet another embodiment is an article of manufacture including the adhesive compositions, wherein the article includes at least two substrates adhesively bonded by an amount of the two part adhesive composition. Typical articles of manufacture include packaged goods, books and magazines; wood articles such as furniture; and articles formed from a combination of low energy and higher energy materials, for example a cardboard box having a polyethylene wrap and/or a polypropylene label, or a wood frame table having a protective plastic top. In general, articles that are advantageously bonded using the adhesive compositions benefit from both the low temperature flexibility, heat resistance and the efficiency of end use in automated means of applying adhesive to substrates.

In one embodiment, comprising a shoe such as a canvas shoe, a leather shoe or an athletic shoe, an upper or upper assembly is bonded to a sole or sole assembly in a multi-step process using at least a solvent based or a contact adhesive. Such methods are slow, inefficient and involve multi steps or a combination of adhesives.

In particular in shoe assembly, conventional shoes are currently made by positioning a shoe upper on a last. The positioned upper is bonded to sole or sole components with use of the adhesive.

### BRIEF DISCUSSION OF FIGURES

FIG. 1 is a side view of a shoe. FIG. 1 is a side view of a shoe as disclosed herein showing a formed shoe wherein the upper of the shoe is bonded to an optional mid-sole and outer sole with the adhesives as disclosed.

FIG. 2 is an expanded or exploded view of an embodiment of the sole of the shoe of the invention. The sole can be a single part outer sole, can include a mid-sole and can include other optional parts for comfort, performance or support.

### DETAILED DISCUSSION

The work piece and adhesive material as disclosed herein can be used to form a final work piece having high green strength and high final bond strength once cured. The work piece can comprise a substrate bonded to a substrate with a layer of the adhesive as disclosed herein positioned there between.

The adhesive composition is disclosed comprises an isocyanate pre-polymer (made by inserting a polyol and an isocyanate) and a reactive polyol polymer combined with optional adhesive components which when applied provides high green strength and final cured strength. The polyols discussed can be used in either the isocyanate pre-polymer or the reactive polyol. In the reactive polyol, use of branded or higher functionality polyols obtain improved green strength.

### Polyol

Polyols can be polyether polyols, polyols are made by the reaction of alkylene oxides or epoxides with active hydrogen containing starter compounds. Useful polymer diols or triols have a molecular weight of from about 500 to 50000, and have at least 50% of the hydroxyl end groups being primary hydroxyl end groups. These polyols are liquids or solids are capable of being blended, liquefied or melted. Examples of diols or triols include linear and branched, aromatic or aliphatic polyester polyols, polyethylene oxide (polyoxyethylene) polyols, polypropylene oxide (polyoxypropylene) polyols, block copolymers of ethylene oxide and propylene oxide. Ethers and esters of tri or higher functional small molecule alcohols, such as glycerin, pentaerythritol etc., can be used. These polyols will be substantially free from functional groups other than hydroxyl groups and moreover, and as mentioned above, will be in the main tipped with primary hydroxyl groups.

### Polyester Polyols

Polyols can be polyester polyols. Polyester polyols can be diols or triols and are manufactured by the direct poly-esterification of high-purity diacids (or lower alcohol esters) and hydroxy compounds. Polyester polyols are usually more expensive and more viscous than polyether polyols, but they make polyurethanes with better solvent, abrasion, and cut resistance.

Other polyester polyols are based on trans-esterification (glycolysis) of poly (ethyleneterephthalate) (PET) or dimethylterephthalate (DMT) isophthalic acid or C₂-C₂₄aliphatic diacids with hydroxy compounds or blends.

Polyester polyol can be made from the following hydroxyl diols and triols reacted with aromatic or aliphatic dicarboxylic acid materials.

Diols and triols used for polyether polyol synthesis

| | | | |
|---|---|---|---|
| | | MW, | Hydroxyl number, |
| No. | Polyol | Daltons | mg KOH/g |

Diols

| | | | |
|---|---|---|---|
| 1 | Ethyleneglycol (EG) | 62.07 | 1807.6 |
| 2 | Diethyleneglycol (DEG) | 106.12 | 1057.2 |
| 3 | 1,2 Propyleneglycol (PG) | 76.10 | 1474.3 |
| 4 | 1,4 Butanediol (BD) | 90.12 | 1245.0 |
| 5 | Neopentyl glycol (NPG) | 104.0 | 1078.8 |
| 6 | 1,6 Hexanediol | 118.18 | 949.3 |
| 7 | 3-methyl-1,5-pentanediol (MPD) | 118 | 950.8 |
| 8 | 1,9-Nonanediol (ND) | 160 | 710.3 |

Triols

| | | | |
|---|---|---|---|
| 1 | Glycerol | 92.10 | 1827.3 |
| 2 | Tri-methylolpropane (TMP) | 122 | 1379.5 |

Hydroxy FCN = 4

| | | | |
|---|---|---|---|
| 1 | Pentaerythritol | 136.15 | 1648.18 |

Aliphatic dicarboxylic acids used for polyester polyol synthesis

| | | MW, | Acid number, |
|---|---|---|---|
| No. | Dicarboxylic acid | Daltons | mg KOH/g |
| 1 | Adipic acid (AA) | 146.14 | 767.78 |
| 2 | Glutaric acid | 132.12 | 849.2 |
| 3 | Succinic acid | 118.09 | 950.1 |
| 4 | Sebacic acid | 202.0 | 555.4 |
| 5 | Azelaic acid | 186.0 | 603.2 |
| 6 | Dodecanedioic acid | 230.3 | 487.2 |

Aromatic dicarboxylic acids and derivatives
used for polyester polyol synthesis

| | | MW, | Acid number, |
|---|---|---|---|
| No. | Dicarboxylic acid | Daltons | mg KOH/g |
| 1 | Iso-phthalic acid (IPA) | 166.13 | 675.3 |
| 2 | Phthalic anhydride | 148.12 | 757.4 |
| 3 | Terephthalic acid | 166.13 | 675.3 |

### Polyether Polyol

Polyether polyols are typically made by reacting an alkylene oxide with a starter compound. As mono-functional starter compounds, alcohols, amines, thiols, and carboxylic acids can be used. As mono-functional alcohols may be used: methanol, ethanol, 1-propanol, 2-propanol, 1-butanol, 2-butanol, tert-butanol, 3-butene-1-ol, 3-butyn-1-ol, 2-methyl-3-buten-2-ol, 2-methyl-3-butyn-2-ol, propargyl alcohol, 2-methyl-2-propanol, 1-tert-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, phenol, 2-hydroxybiphenyl, 3-hydroxybiphenyl, 4-hydroxybiphenyl, 2-hydroxypyridine, 3-hydroxypyridine, 4-hydroxypyridine. As monofunctional amines are: butylamine, tert-butylamine, pentyl amine, hexylamine, aziridine, pyrrolidine, piperidine, morpholine. Mono functional substituted compounds can be used. Monofunctional carboxylic acids: formic acid, acetic acid, propionic acid, butyric, acid, fatty acids such as stearic acid, palmitic acid, oleic acid, linoleic acid, linolenic acid, benzoic acid, acrylic acid can also be used. Di- or tri-H-functional starter substances suitable polyhydric alcohols include dihydric alcohols (such as ethylene glycol, diethylene glycol, propylene glycol, dipropylene glycol, 1,3-propanediol, 1,4-butanediol, 1,4-butenediol, 1,4-butynediol, neopentyl glycol, 1,5-Pentantandiol, methylpentanediols (such as 3-methyl-1,5-pentanediol), 1,6-hexanediol, 1,8-octanediol, 1,10-decanediol, 1,12-dodecanediol, bis (hydroxymethyl)-cyclohexane (such as 1,4-bis (hydroxymethyl) cyclohexane), triethylene tetraethylene glycol, polyethylene glycols, dipropylene glycol, tripropylene glycol, polypropylene glycols, dibutylene glycol and polybutylene glycols), trihydric alcohols (such as trimethylolpropane, glycerol, trihydroxyethyl isocyanurate, castor oil); tetrahydric alcohols (for example pentaerythritol), polyalcohols (such as sorbitol, hexitol, sucrose, starch, starch hydrolyzates, cellulose, cellulose hydrolysates, hydroxy fats and oils, in particular castor oil), as well as any modification products of these aforementioned alcohols with varying amounts of ε-caprolactone.

Polyols use ethylene glycol, dipropylene glycol (functionality 2), glycerin (functionality 3) or a sorbitol/water solution (functionality 2.75). sucrose (functionality 8), sorbitol (functionality 6), toluenediamine (equivalent of 4 hydroxyl). Propylene oxide and/or ethylene oxide is added to the initiators until the desired molecular weight (greater than about 500 to 10,000) is achieved. The order of addition and the amounts of each oxide affect many polyol properties, such as compatibility, water-solubility, and reactivity. Polyols made with only propylene oxide are terminated with secondary hydroxyl groups and are less reactive than polyols capped with ethylene oxide, which contain a higher percentage of primary hydroxyl groups.

Polyether polyols can be represented by Formula III:

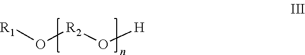

Wherein R₁ represents an initiator compound residue, R₂ is a C₂₋₄ alkylene group and n is a number of 2 to 200. The group R₂—O— also represents a polymer residue of polymerized ethylene oxide, propylene oxide or mixtures thereof. Due to their high hydroxyl number dendritic polyols are not useful in the claimed compositions. Exemplary compounds are:

Active hydrogen or hydroxyl compounds
used for the synthesis of polyols

| | | Molecular weight | Hydroxyl number |
|---|---|---|---|
| Starter | Functionality | (Daltons) | (mg KOH/g) |
| Ethanol | 1 | 31 | 5500.0 |
| Water | 2 | 18 | 6233.3 |
| Ethylene glycol | 2 | 62 | 1807.9 |
| Diethylene glycol | 2 | 106 | 1057.4 |
| 1,2 Propylene | 2 | 76.1 | 1474.6 |
| glycol | | | |
| Dipropylene glycol | 2 | 134.2 | 836.3 |
| (DPG) | | | |
| Glycerin | 3 | 92 | 1829 |
| Tri-methylol | 3 | 134.2 | 1254.1 |
| propane | | | |
| 1,2,6 Hexanetriol | 3 | 134 | 1255 |
| Triethanolamine | 3 | 146 | 1152.7 |
| Ethylenediamine | 4 | 60 | 3740 |
| Pentaerythritol | 4 | 136.15 | 1648.18 |

Using a functionality of 2 obtains at least a polyether diol. Using functionality of 3 obtains at least a polyether triol. Using a functionality of 4 obtains a polyether tetrol with a hydroxyl functionality of at least 4. Polyol with functionality greater than 2 or about 3 or more obtain increased green strength. Suitable linear or substantially linear polyether polyols are polyalkylene ether glycols obtained by polyaddition reactions, i.e., polymerization; copolymerization and the like, of alkylene oxides, glycols, heterocyclic ethers and other similar materials, either singly or in combination. Examples of such polyether polyols include the polyoxy alkylene glycols prepared by the addition of alkylene oxide to Water, to alkylene glycol, or to dialkylene glycol, e.g., polyoxyethylene glycol; polyoxypropylene glycol and mixed oxyethylene-oxypropylene polyglycols prepared. in a similar manner; polyether glycols prepared by reacting ethylene glycol, propylene oxide, or mixtures thereof, with mono and poly-nuclear hydroxyl benzenes, e.g., catechol, resorcinol. Exemplary compounds are: hydroquinone, 2,2-bis(p-hydroxyphenol) propane, bis(p-hydroxyphenol)methane and the like; polyneopentylene ether glycol, polytetramethylene ether glycol, polypentamethylene ether glycol, polyhexamethylene ether glycol, poly-1,6-heptamethylene ether glycol and the like. Additionally, polyalcohols such as the aforementioned diols, triols, tetrols and polyols, e.g., alkylene glycols, glycerin, trimethyl propane, 1,2,6-hexanetriol, pentaerythritol, etc. generally may be used.

In greater detail, polyester polyols are formed from the condensation of one or more polyhydric alcohols having from 2 to 15 carbon atoms with one or more polycarboxylic acids having from 2 to 14 carbon atoms. Examples of suitable polyhydric alcohols include ethylene glycol, propylene glycol such as 1,2-propylene glycol and 1,3-propylene glycol, glycerol, pentaerythritol, trimethylolpropane, butanediol, pentanediol, hexanediol, dodecanediol, octanediol, chloropentanediol, glycerol monallyl ether, glycerol monoethyl ether, diethylene glycol, 2-ethylhexanediol-1,4, cyclohexanediol-1,4,1,2,6-hexanetriol, 1,3,5-hexanetriol, 1,3-bis-(2-hydroxyethoxy)propane and the like. Examples of polycarboxylic acids include phthalic acid, isophthalic acid, terephthalic acid, tetrachlorophthalic acid, maleic acid, dodecylmaleic acid, octadecenylmaleic acid, fumaric acid, aconitic acid, trimellitic acid, tricarballylic acid, 3,3′-thiodipropionic acid, succinic acid, adipic acid, suberic acid, azelaic acid, malonic acid, glutaric acid, pimelic acid, sebacic acid, cyclohexane-1,2-tricarboxylic acid, 1,4-cyclohexadiene-1,2-dicarboxylic acid, 3-methyl-3,5-cyclohexadiene-1,2-dicarboxylic acid and the corresponding acid anhydrides, acid chlorides and acid esters such as phthalic anhydride, phthaloyl chloride and the dimethyl ester of phthalic acid. Dimer fatty acids can also be used, where they are the dimerization product of mono- or polyunsaturated acids and/or esters thereof. Preferred dimer fatty acids are dimers of C₁₀- to a C₃₀, more preferably C₁₂- to a C_{2A}, particularly C₁₄- to a C₂₂ and especially Cis alkyl chains. Suitable dimer fatty acids include the dimerisation products of oleic acid, linoleic acid, linolenic acid, palmitoleic acid and elaidic acid. The dimerisation products of the unsaturated fatty acid mixtures obtained in the hydrolysis of natural fats and oils, e.g., sunflower oil, soybean oil, olive oil, rapeseed oil, cottonseed oil and tall oil may also be used. In addition to the dimer fatty acids, dimerisation usually results in varying amounts of oligomeric fatty acids (so called “trimer”) and residues of monomeric fatty acids (so-called “monomer”), or esters thereof, being present. Suitable dimer fatty acids have a dimer acid content greater than 60%, preferably greater than 75%, more preferably in the range 90 to 99.5%, particularly 95 to 99%, and especially 97 to 99%. Commercially available polyesters which may be used include crystalline and amorphous materials such as Dynacoll 7360, 7380, 7330, 7231, 7250 evonick, Rucoflex S-105-10 (Bayer), Stepanpol PN110 (Stepan), Priplast 3196 (Croda). Typical molecular weight ranges from about 1000 to about 7000.

Dynacoll® 7130, available from Huls America, is a polyester polyol.

Dynacoll® 7250, available from Huls America, was a liquid copolyester polyol comprising the reaction product of adipic acid, ethylene glycol, neopentyl glycol and 1,6-hexane diol having a molecular weight of about 5500 and a Tg of about −50° C.

Dynacoll® 7340, available from Huls America, was a crystalline copolyester polyol comprising the reaction product of terephthalic acid, adipic acid, and 1,6-hexanediol having a molecular weight of about 3500 and a melting point of about 96° C.

Dynacoll® 7360, available from Huls America, was a crystalline copolyester polyol comprising the reaction product of adipic acid and 1,6-hexane diol having a molecular weight of about 3500 and a melting point of about 55° C.

Dynacoll® 7380, available from Huls America, was a crystalline copolyester polyol comprising the reaction product of dodecanedioic acid and 1,6-hexane diol having a molecular weight of about 3500 and a melting point of about 70° C.

Pearlbond® 101Pearlbond® 102 Pearlbond® 103 Pearlbond® 104 Pearlbond® 501—a linear, polycaprolactone-copolyester solid polyurethane particulate, supplied in form of white spherical granules with a high crystallization rate and a very high thermo plasticity level.

As noted above, the claimed adhesives provide improved green strength prior to final bond formation through the urethane reaction. We have found that the improved green strength is obtained at least in part from the use of nonlinear polymer materials. By nonlinear polymer materials in the pre-polymers we mean that the pre-polymers are branched. We have found that a pre-polymer functionality of greater than two or about three or four obtains improved green strength. By functionality we mean that the polymers have a branch structure having three or four end group termination structures typically ending in —OH groups. We have also found that the use of such nonlinear polymers with relatively low molecular weights enhances tack. The molecular weights of the pre-polymer typically range from 2500 to about 5000 (MWn) number average molecular weight in the adhesives claimed in this application.

Isocyanates are used to make the NCO propolymer and are very reactive materials. Aromatic isocyanates, diphenylmethane diisocyanate (MDI) or toluene diisocyanate (TDI) are more reactive than aliphatic isocyanates, such as hexamethylene diisocyanate (HDI) or isophorone diisocyanate (IPDI). Isocyanates are difunctional; two isocyanate groups per molecule. Commercial polymeric diphenyl methane diisocyanate is a mixture of molecules with two-, three-, and four- or more isocyanate groups. In cases like this the material has an average functionality greater than two, commonly 2.7.

Useful aromatic diisocyanates are 2,4- and 2,6-toluene diisocyanate (TDI); 2,2′-, 2,4′-, and 4,4′-methylenediphenylene diisocyanate (MDI); and 1,4-phenylene diisocyanate; cycloaliphatic diisocyanates such as isophorone diisocyanate (IPDI) and hydrogenated methylenediphenylene diisocyanate (HMDI); and aliphatic diisocyanates such as 1,6-diisocyanatohexane and 1,8-diisocyanatooctane. Suitable polyisocyanates include polymeric MDI having average functionalities of from 2.2 to 2.4, and in particular triisocyanates, e.g. 1,3,5-triisocyanato benzene, and triisocyanates and higher functional isocyanurates prepared by reacting di- or polyisocyanates with themselves in the presence of a trimerization (isocyanurate-promoting catalyst). Such isocyanurate triisocyanates are commercially available, for example as the isocyanurate of isophorone diisocyanate, having a nominal functionality of 3.0. This isocyanate has a melting point range of from about 110° C. to 115° C. Other examples of multifunctional isocyanates include Desmodur N75, Desmodur Z4470, Desmodur N3300, Desmodur N3600 available from Bayer. The prepolymer is prepared by the polymerization of excess polyisocyanate with a polyol. Organic polyisocyanates include alkylene diisocyanates, cycloalkylene diisocyanates, aromatic diisocyanates and aliphatic-aromatic diisocyanates. In greater detail, specific examples of suitable isocyanate-containing compounds include, but are not limited to, ethylene diisocyanate, ethylidene diisocyanate, propylene diisocyanate, butylene diisocyanate, trimethylene diisocyanate, hexamethylene diisocyanate, 2,4-toluene diisocyanate, cyclopentylene-1,3-diisocyanate, cyclo-hexylene-î-diisocyanate, cyclohexylene-1,2-diisocyanate, 2,6-toluene diisocyanate, 4,4′-diphenylmethane diisocyanate, 2,4′-diphenylmethane diisocyanate, 2,2-diphenylpropane-4,4′-diisocyanate, xylylene diisocyanate, trimethyl xylylene diisocyanate, 1,4-naphthylene diisocyanate, 1,5-naphthylene diisocyanate, m-phenylene diisocyanate, p-phenylene diisocyanate, diphenyl-4,4′-diisocyanate, azobenzene-4,4′-diisocyanate, diphenylsulphone-4,4′-diisocyanate, 2,4-tolylene diisocyanate, dichlorohexa-methylene diisocyanate, furfurylidene diisocyanate, 1-chlorobenzene-2,4-diisocyanate, 4,4′,4″-triisocyanatotriphenylmethane, 1,3,5-triisocyanato-benzene, 2,4,6-triisocyanato-toluene, 4,4′-dimethyldiphenyl-methane-2,2′,5,5-tetratetraisocyanate, and the like. While such compounds are commercially available, methods for synthesizing such compounds are well known in the art. Preferred isocyanate-containing compounds are methylenebisphenyldiisocyanate (MDI), isophoronediisocyanate (IPDI), hydrogenated methylenebisphenyldiisocyanate (HMDI) and toluene diisocyanate (TDI). The polyols of the disclosure that are used to make polyurethane adhesives are not “pure” compounds since they are often mixtures of similar molecules with different molecular weights and mixtures of molecules that contain different numbers of hydroxyl groups, which is why the “average functionality” is often mentioned. The polymerization reaction makes a polymer containing the urethane linkage, —RNHCOOR′— and is catalyzed by tertiary amines, such as 1,4-diazabicyclo [2.2.2] octane (also called DABCO or TEDA), DMDEE (2,2′-dimorpholino diethyl ether) and metallic compounds, such as dibutyltin dilaurate or bismuth octanoate.

Polyurethane catalysts can be classified into two broad categories, amine compounds and metal complexes. Traditional amine catalysts have been tertiary amines such as triethylenediamine (TEDA, 1,4-diazabicyclo[2.2.2]octane or DABCO), dimethylcyclohexylamine (DMCHA), and dimethyl ethanolamine (DMEA). Tertiary amine catalysts are selected based on whether they drive the urethane (polyol+isocyanate, or gel) reaction or the isocyanate trimerization reaction (e.g., using potassium acetate, to form isocyanurate ring structure). Catalysts that contain a hydroxyl group or ary amine, which react into the polymer matrix, can replace traditional catalysts thereby reducing the amount of amine that can come out of the polymer.

A large variety of polymer materials can be used to increase initial green strength or final cohesive strength of the adhesive blend and final cured material. For the purpose of this application, a polymer is a general term covering either a thermoset or a thermoplastic. Polymer materials useful include both condensation polymeric materials and addition or vinyl polymeric materials. Included are both vinyl and condensation polymers, and polymeric alloys thereof. Vinyl polymers are typically manufactured by the polymerization of monomers having an ethylenically unsaturated olefinic group. Condensation polymers are typically prepared by a condensation polymerization reaction which is typically considered to be a stepwise chemical reaction in which two or more molecules combined, often but not necessarily accompanied by the separation of water or some other simple, typically volatile substance. Such polymers can be formed in a process called polycondensation.

Vinyl polymers include polyethylene, polypropylene, polybutylene, acrylonitrile-butadiene-styrene (ABS), polybutylene copolymers, polyacetyl resins, polyacrylic resins, homopolymers or copolymers comprising vinyl chloride, vinylidene chloride, fluorocarbon copolymers, etc. Condensation polymers include nylon, phenoxy resins, polyarylether such as polyphenylether, polyphenylsulfide materials; polycarbonate materials, chlorinated polyether resins, polyethersulfone resins, polyphenylene oxide resins, polysulfone resins, polyimide resins, thermoplastic urethane elastomers and many other resin materials.

Condensation polymers that can be used include polyamides, polyamide-imide polymers, polyarylsulfones, polycarbonate, polybutylene terephthalate, polybutylene naphthalate, polyetherimides, polyethersulfones, polyethylene terephthalate, thermoplastic polyimides, polyphenylene ether blends, polyphenylene sulfide, polysulfones, thermoplastic polyurethanes and others. Preferred condensation engineering polymers include polycarbonate materials, polyphenyleneoxide materials, and polyester materials including polyethylene terephthalate, polybutylene terephthalate, polyethylene naphthalate and polybutylene naphthalate materials.

Polymer blends or polymer alloys can be useful and typically comprise two miscible polymers blended to form a uniform composition. Scientific and commercial progress in the area of polymer blends has lead to the realization that important physical property improvements can be made not by developing new polymer material but by forming miscible polymer blends or alloys. A polymer alloy at equilibrium comprises a mixture of two amorphous polymers existing as a single phase of intimately mixed segments of the two macro molecular components. Miscible amorphous polymers form glasses upon sufficient cooling and a homogeneous or miscible polymer blend exhibits a single, composition dependent glass transition temperature (Tg). Immiscible or non-alloyed blend of polymers typically displays two or more glass transition temperatures associated with immiscible polymer phases. In the simplest cases, the properties of polymer alloys reflect a composition weighted average of properties possessed by the components. In general, however, the property dependence on composition varies in a complex way with a particular property, the nature of the components (glassy, rubbery or semi-crystalline), the thermodynamic state of the blend, and its mechanical state whether molecules and phases are oriented. One useful blend comprises a EUA polymer and a polyolefin.

The composition may also include a tackifing resin, which are low molecular weight natural or petroleum based materials. Suitable tackifiers include, without limitation, rosin, rosin derivatives, rosin ester, aliphatic hydrocarbons, aromatic hydrocarbons, aromatically modified aliphatic hydrocarbons, aliphatically modified aromatic hydrocarbons, terpenes, terpene phenolic. Additional components employed in some embodiments of the hot melt adhesive compositions of the invention include tackifing resins. Tackifing resins, or tackifiers, typically have low molecular weights and are resinous, and have glass transition and softening point temperatures well above typical room temperatures. In some embodiments, tackifing resins are based on natural products, for example terpenes, which are based on polymerized α- or β-pinene based compounds. In other embodiments, petroleum-based hydrocarbon resins are tackifing resins useful in the hot melt adhesive compositions of the invention. Such materials are often formed by polymerization of aliphatic hydrocarbon materials to form an amorphous polymer. In embodiments, the petroleum hydrocarbon resin is hydrogenated or modified with aromatic functionality to improve thermal stability. In embodiments, the tackifing resins useful in the hot melt adhesive compositions of the invention have a softening point of about 70° C. to 180° C., or in some embodiments about 100° C. to 150° C. or 70° C. to 130°. Examples of tackifing resins that are useful in the hot melt adhesive compositions of the invention include those sold by ExxonMobil Chemical under the trade name ESCOREZ®, such as ESCOREZ® 5600, 5615, 5637, and 5690; those sold by Arizona Chemical Co. of Jacksonville, Fla. under the trade name SYLVARES™; those sold by Cray Valley of Paris, France under the trade name WINGTACK®; those sold by Pinova, Inc. of Brunswick, Ga. under the trade name PICCOLYTE®; and those sold by Eastman Chemical Co. of Kingsport, Tenn. under the trade names EASTOTAC® and REGALREZ®. In embodiments where tackifing resin is employed in the hot melt adhesive compositions of the invention, it is added at about 1 wt % to 30 wt % based on the total weight of the composition, or about 5 wt % to 20 wt % based on the total weight of the composition. Since the tackifier in certain embodiments is an optional component of the hot melt adhesive composition of the invention, any of the recited ranges include 0 wt % to any of the recited amounts in various embodiments, for example 0 wt % to 1 wt %, 0 wt % to 50 wt % based on the total weight of the adhesive.

Suitable fillers useful in the present composition are well known; examples of which include clay, talc, calcium, and magnesium silicates, calcium carbonate, wood flour, hydrated alumina, etc. The particulate filler useful for making the adhesive tie layer can be an inorganic or organic material and is preferably a rigid material. Specific examples of inorganic particulate fillers include metal carbonates, such as barium carbonate; calcium carbonate; magnesium carbonate; metal hydroxides, such as, aluminum hydroxide; magnesium hydroxide; metal oxides, such as, calcium oxide; magnesium oxide; titanium oxide; titanium dioxide zinc oxide; metal sulfates, such as, barium sulfate; calcium sulfate; magnesium sulfate; clay: kaolin: talc; silica; diatomaceous earth; alumina; mica; glass powder; and zeolite materials.

Organic particulate materials can also be used as fillers, as for example, finely divided cellulosic fibers, and in particular such fibers obtained from wood pulps as used in the paper industry. Solid polyurethane particulate fillers improves the cohesive strength of the material after formation. Commercial examples of suitable particulate filler concentrates include Heritage HM-10 (Heritage Plastics) and Omyacarb 2SST (OMYA, Inc.). These filler concentrates contain the filler, in this case calcium carbonate, at loadings of about 30 to about 80%, preferably about 50 to about 75% by weight of the carrier resin. The average size of the particulate filler should be about 0.1 micron to about 10 microns, preferably, about 0.5 microns to about 5 microns, and more preferably about 0.8 microns to about 3 microns. Representative of preferred fillers are calcium carbonate, clay, TiO₂, and silica. Calcium carbonate is particularly preferred filler because it is relatively inexpensive and readily available. Filler content ranges from about 50 percent to about 75 percent by weight, based on the total composition, while amounts between about 52 and 60 percent are generally considered most preferable. In some cases, it can be as low as 5-30%.

Antioxidants may be optionally added to the adhesive. Various antioxidants based on different chemistries are supplied, for example, by Ciba under the trade name Irganox, Irgafos or Irgastab. Blends of antioxidants may be preferred for the adhesive, for there is a synergistic effect of such combination. Antioxidants may be used in the concentration range 0.1-10%, preferably 0.5-5%, based on the total weight of the adhesive.

Other suitable additives for use may be any compound which will not interfere with the efficacy of the other components in the adhesive composition and which increases adhesion. Suitable additives include, but are not limited to, reactive or non-reactive polymers, fillers, plasticizers, viscosity control agents, defoamers and stabilizers. The additives are typically employed in the range of 0.1-10 wt0%, preferably 0.5-5.0 wt %.

### Adhesive Technology

Polyurethane prepolymer are produced by reacting an isocyanate containing two or more isocyanate groups with a polyol containing on average two or more reactive hydrogen atoms such as a sulfhydryl, an amine hydrogen or hydroxyl group hydrogen per molecule typically in the presence of a catalyst.

The adhesive compositions are formed from the two part adhesive and are applied as coatings, beads, fine lines, dots, patches, or spray coatings; in a continuous or intermittent fashion; or generally in any fashion in which conventional adhesive formulations are applied. Coatings can be applied by slot coating. Spray-on application involves delivery of adhesive from a plurality of narrow orifices in the form of a film, bead, fiber, thread or filament having a substantially flat, rectangular or circular cross section with a major diversion less than 2 cm, in some embodiments about 1 to 0.002 cm. Fine line or spiral spray patterns are used in various embodiments. The adhesives are applied by spray or other application apparatuses, in a liquid or molten state onto a substrate. The substrate is then applied to the adhesive to bond the substrates. In some embodiments wherein the substrates are porous (for example, a polypropylene nonwoven, or a cellulose tissue), more than two substrate layers are adhesively bonded together by one applied aliquot of adhesive followed by application of pressure to the substrates/adhesive composition layers during the open time. For example, a, substrate such as a plastic film or sheet is provided, onto which a bead of adhesive composition is applied. Then two or more layers of substrate(s) such as, for example, a cotton batting, a thermoplastic nonwoven fabric such as a polyolefin or polyester nonwoven fabric, and/or a woven fabric such as a cotton or cotton/polyester blend woven fabric, are placed on top of the substrate and pressure is applied, for example by a roller, to cause all the substrates to become adhesively affixed. Adhesion of multiple layers in this manner is possible because the adhesive can be extruded directly onto a substrate.

The coating of adhesive can be 2 inches to 48 in width, 1 mil to 20 mil thick and an adhesive add on of about 0.01 to 20 grams/ft² of coating.

The length of the bead applied to the substrate depends on the size of the substrate and the length of the bond required between the substrates. The length of the bead will vary depending on the application and the size and type of substrates being employed.

Typical but nonlimiting industrial applications of the compositions include shoe assembly, packaging, particularly for low temperature use such as for dairy products or for freezer packaging of food products, and in sanitary disposable consumer articles, for example, diapers, feminine care pads, napkins, etc. Traditional end use applications such as athletic shoes, book-binding, wood working and labeling will also benefit from both the low temperature flexibility, heat resistance and the efficiency of end use in automated means of applying the compositions to various substrates.

In industrial applications, the rapid effective set time of the adhesive compositions provide a broader scope of utility than are realized with conventional hot melt and contact adhesives. In some embodiments, the adhesive compositions have an effective set time of less than 5 seconds, and in some embodiments the effective set time is as short as 0.1 seconds. Such a rapid effective set time is, for industrial purposes, “instant”, and represents a significant advantage for industrial uses of adhesives. A rapid effective set time enables the use of the adhesive composition in industrial applications that previously did not employ adhesives because the long effective set time represented a bottleneck in productivity.

In forming a bond between substrates the adhesive material is extruded onto one or both the substrate surfaces, the substrates are contacted in such a way that the adhesive forms a bond between the substrates. In bond formation, initially the adhesive forms a “green strength” bond and the reactive components of the adhesive then form bonds throughout the adhesive mass obtaining a final adhesive bonding. The claimed adhesives are formulated such that the adhesives can bond a variety of substrate materials. The adhesive can be used to bond metals, polymeric materials, cellulosic materials, inorganic materials and other common substrates. The surface energy of the substrate can have an impact on bond quality. Surface energy is defined as the sum of intermolecular forces available at the surface of a material. Surface energy can be considered the degree of attraction or repulsion force of a material surface that is exerted on material in content. When a substrate has high surface energy it tends to attract other liquids and solids having high surface energies. Adhesives should be formulated to obtain an excellent “wetting” of the adhesive on the substrate.

Relatively low surface energy materials i.e., materials having a surface energy less than 30 dyne/cm are difficult to bond. We have found that the adhesive bonds are formed with substrates having a surface energy greater than about 38 dyne/cm or greater preferably 40 dyne/cm. In this way both similar and dissimilar substrates can be bonded using a single adhesive material regardless of surface energy. If the surface energy is low particularly less than 30 dyne/cm, a primer material can be coated onto the low surface energy surface. The use of a primer layer can increase the surface energy of a substrate to greater than 38 dyne/cm and preferably greater than 40 dyne/cm. Typically the primer layer consists of a polymeric material having affinity to the substrate but providing a surface energy of the desired level. The primer can be applied in a variety of fashions. The primer can be sprayed on in melt form applied as hot melt dots, metered on with a knife or other application technologies, the primer is applied from solvent solution. Such primers are manufactured by obtaining a polymer having a suitable surface energy in a film surface, dissolving the polymer in a compatible solvent and applying the solvent-based polymer material permitting the solvent to evaporate thus forming a high surface energy surface on the substrate layer. Preferably a polymer is selected such that the polymer can interact with the substrate polymer obtaining a well-formed polymer layer that is mechanically stable on the surface of the substrate. The following table lists initially polymers with low surface energy that require primer for improved adhesion followed by polymers that can be used as primer materials or having a higher surface energy requiring less primer or none at all.

| Name | CAS Number | γₛ |
|---|---|---|
| TEFLON | — | 2.4 |
| EMA | 97-63-2 | 2.4 |
| FEP | 25067-11-2 | 18.5 |
| PE | 9002-88-4 | 33.5 |
| PP | | 30.2 |
| Polyisoprene | 9003-31-0 | 32.3 |
| PVDF | 24937-79-9 | 31.5 |
| ABS | 9003-56-9 | 42 |
| EPDM | 25038-36-2 | 32.5 |
| HEMA | 867-77-9 | 56.8 |
| Nylon 66 | 32131-17-2 | 42.2 |
| Nylon 610 | 9008-66-6 | 40.5 |
| PAN | 21014-41-9 | 46.8 |
| Polybutadiene | 9003-17-7 | 45.9 |
| PET | 25038-59-9 | 44 |

In the manufacture of articles using the claimed adhesives, commonly two substrates to be bonded are adhered by applying the claimed adhesive on either or both substrates, contacting the substrates with the adhesive bond formed there between and carrying the adhesive material.

The adhesive can be applied to the substrates in a variety of methods, the adhesives can be sprayed on in droplets, can be sprayed on in the form of patterns of adhesive filaments or strings, the adhesive can be applied using a 3D printer, the adhesive can be applied in a bead form, in a dot form or any other conventional adhesive application mode. The claimed adhesives can be formed into film layers by extruding the adhesive onto a form in the shape of the desired bond layer having a thickness of about 0.1 to 2 millimeters and then removing the formed film and storing the film under conditions that prevent the adhesive from reacting. Such adhesives should be maintained in a cold temperature under inert (i.e.) nitrogen atmosphere and in the substantial absence of any moisture or other curing mechanism.

In a preferred mode, the adhesive of the invention is used in the manufacture of shoes. In such manufacture, the adhesive claimed is preferably extruded onto a sole which can be primed if necessary, once applied to the sole, the adhesive layer on the sole can be contacted with an upper that can be primed if necessary. The resulting assembly is then bonded by curing the adhesive bond forming a permanent flexible bond between sole and upper. Often after contacting the sole with the upper, the adhesive can be forced from the bond area onto the periphery of the sole resulting in “squeeze out” of the adhesive on the exterior of the shoe assembly. This “squeeze out” is not desirable and can be removed with a variety of techniques. The squeeze out can be removed manually using a variety of tools. The squeeze out can be removed using abrasive techniques such as sandpaper, etc. One preferred mode of squeeze out removal is the use of a sandblast technique. We have found that the use of a cold or frozen medium sandblasting technique is most useful in removing squeeze out. In such a technique, after the shoe bond is fully cured and set, the squeeze out is removed by directing a blast of high speed but cold particulate and to squeeze out. The cold blast first chills the adhesive resulting in a more brittle material and the mechanical action of the cold particulate removes the squeeze out efficiently leaving little or no residue. Preferred particulate in such a technique includes frozen water pellets, frozen carbon dioxide pellets, or other chilled small particulate materials.

### Exemplary Section

The following examples and data (reflected in the figures of the conversion of the materials into polyester) show the utility of the processes in obtaining high quality polyol materials for use in the compositions of the disclosure. The preparations are exemplary of adhesive materials but should not be used in unduly limiting the scope of the claims.

TABLE
COMPOSITIONS USED IN THE FORMULATIONS

| Trade name | Chemical Identity |
|---|---|
| PPG | polypropylene glycol |
| PEG | Polyethylene glycol |
| Dynacoll 7210 | Polyester |
| Dynacoll 7130 | Polyester |
| Dynacoll 7250 | Polyester |
| Dynacoll 7360 | Polyester |
| Dynacoll 7380 | Polyester |
| CAPA 5600 | Polyester |
| 3500 EAT | Polyester |
| 3500 HD | Polyester |
| 1000 NP | Polyester |
| Krystalex 3085 | Tackifier resin |
| DMDEE | Initiator |
| EVA 4030 | Ethylene Vinyl Acetate resin |
| LHT-112 | Polyether Polyol |
| LHT-240 | Polyether Polyol |
| Vestoplast | Polyolefin APAO |
| Irganox | Stabilizer |
| MDI | Diphenyl methane diisocyanate |
| MLQ | Diphenyl methane diisocyanate (monomeric) |
| Benetex OB | Optical brightener |
| Omyacarb SFL | CaCO₃ |
| Flowing agent | |

### Experimental Section:

In the following exemplary tables, the adhesives are made by thermally processing the isocyanate pre-polymer and separately processing the reactive pre-polymer materials. In the manufacture of the isocyanate pre-polymer, the individual components including the polyols additives and isocyanate compounds are blended and in typical urethane reaction vessels are heated to a temperature between 260-270° F. under a vacuum for at least 60 minutes until the moisture content of the blended material is below an amount that would cause a moisture curing reaction that is unwanted in the pre-polymer. The typical sealing for moisture content is approximately 400 parts per million of water or less per million parts of the reaction mixture or less than 200 parts per million of water. After equilibration and reduced moisture content, the amount of isocyanate compound is added at a temperature of 200-240° F. and the reaction mixture is stirred and reacted for one and a half hours at 270-280° F. and should fully reaction between the isocyanate compound and the reactive hydroxyls in the mixture When complete the Brookfield viscosity using No. 27 spindle at 140 degrees centigrade is 4100 cP. The NCO content can be from 5 to 6% typically 5.2 to 5.7%. Often the viscosity can range from about 4500-30000 cP at 285° F. using a Brookfield viscometer with spindle no. 27 at 285° F. The final adhesive formulation is made by combining all ingredients of the polyol part except for pre-polymer and activator. The components are mixed in conventional polyurethane reaction vessels and are heated to 290-300° F. for 30 minutes to remove water. The temperature is re-raised to 250° F. The isocyanate pre-polymer is added to the polyol. The mixture is mixed while reacted at 285° F. for three hours. After that period of time, the activator is added and mixed until the uniform typically 15 minutes. The isocyanate content is typically about 3 to 4% often 1.5.0 to 2.5%. The viscosity of the material using a Brookfield viscometer and a No. 27 spindle at 285° F. is 26940 cP.

### Example 1

### Prepolymer

| | | | eq. wt. | % wt | OH | NCO |
|---|---|---|---|---|---|---|
| polypropylene glycol | PPG-1000 | 14.220 | 500 | 14.2186% | 0.0284 | x |
| Ethylene glycol Hexanediol- | Dynacoll7250 | 16.330 | 2550 | 16.3284% | 0.0064 | x |
| Neopentyl glycol adipate | | | | | | |
| polyester polyol MW = 3500, | | | | | | |
| OH number 27-34 (aliphatic) | | | | | | |
| stabilizer | Irganox 1010 | 0.160 | 10000000 | 0.1600% | 0.0000 | x |
| optical brightener | Benetex OB | 0.020 | 10000000 | 0.0200% | 0.0000 | x |
| Dodecandioic acid-hexanediol | Dynacoll 7380 | 25.000 | 1750 | 24.9975% | 0.0143 | x |
| polyester polyol, MW = 3500, OH | | | | | | |
| nubmer 27-34 (aliphatic) | | | | | | |
| Hexanediol-adipate polyester | Dynacoll 7360 | 20.00 | 1750 | 19.9980% | 0.0114 | x |
| polyol MW = 3500, OH number | | | | | | |
| 27-34 (aliphatic) | | | | | | |
| Di phenyl methane di isocyanate | MDI | 24.280 | 125 | 24.2776% | x | 0.1942 |
| | | | | 100.0000% | | |
| | | 100.0100 | NCO % | 5.61% | 0.0606 | 0.1942 |

### Example 2

### Adhesive

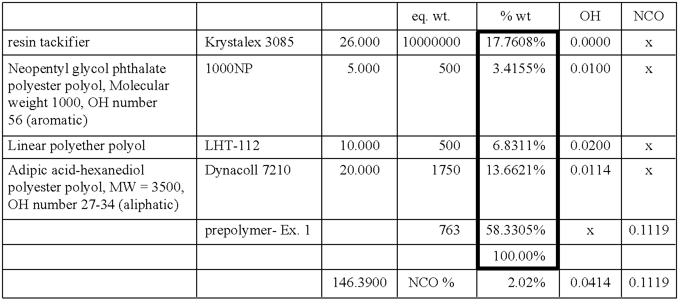

Actual viscosity at 285 F.: 25660cP
Actual NCO %. 210%
Roller coated on polyacrylic plastic, bonded to plastic to plastic, it showed great adhesion (P30-3 P68)
Roller coated on polyacrylic PE & PS plastic, bonded to plastic to plastic, it showed great adhesion (P30-3 P68)
Plastic surface energy 34-36 dyne/cm
Coating weight 10.4 g/ft², open time 2 min 10 sec
This fomula has great adhesion to plastic, it stick to PVC, PE, PP, PS and acrylic plastics

### Example 3

### Prepolymer

| | | | eq. wt. | % wt | OH | NCO |
|---|---|---|---|---|---|---|
| Linear poly polyol | Polyether polyol | 9.000 | 500 | | 0.0180 | x |
| | T-1000 | | | | | |
| Hexanediol-adipate polyester polyol | Dynacoll 7210 | 9.000 | 1750 | | 0.0051 | x |
| MW = 3500, OH number 27-34 (aliphatic) | | | | | | |
| stabilizer | Irganox 1010 | 0.100 | 10000000 | | 0.0000 | x |
| brightener | Benetex OB | 0.010 | 10000000 | | 0.0000 | x |
| Dodecandioic acid-hexanediol polyester | Dynacoll 7380 | 19.700 | 1750 | | 0.0113 | x |
| polyol, MW = 3500, OH nubmer 27-34 | | | | | | |
| (aliphatic) | | | | | | |
| Ethylene gycol-adipic acid-iso-terephlate | Dynacoll 7130 | 10.000 | 1500 | | 0.0067 | x |
| polyester polyol, MW = 3500, OH number | | | | | | |
| 27-34 (aromatic-aliphatic) | | | | | | |
| diphenyl methane di isocyanate | MDI | 15.500 | 125 | | x | 0.1240 |
| | | | NCO % | | 0.0411 | 0.1240 |
| | | 63.3100 | NCO % | 5.50% | 0.0411 | 0.1240 |

Actual viscosity 5540 cP
Actual NCO %: 5.3%
Viscosity range at 285° F.: 4500-6500 cP

### Example 4

### Adhesives

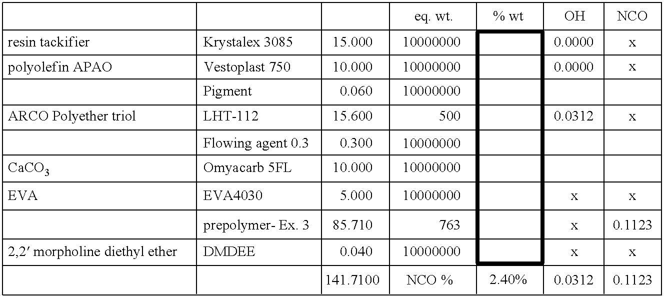

Viscosity at 275° F.: 27200cP
NCO %: 2.10%
Open time 45 sec

### Example 5

### Adhesives

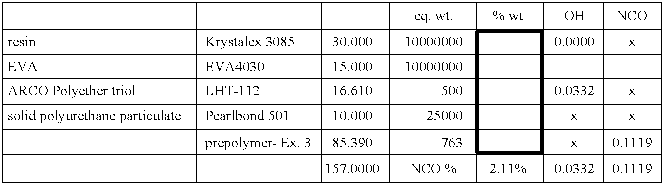

Actual viscosity at 275 F.: 27200cP Actual NCO %: 2.10% Open time 3 min 20 sec

### Example 6

### Prepolymer

| | | | eq. wt. | % wt | OH |
|---|---|---|---|---|---|
| poly propylene glycol | PPG-1000 | 9.000 | 500 | | 0.0180 |
| Ethylene gycol-adipic acid- | Dynacoll 7210 | 9.000 | 1750 | | 0.0051 |
| Terephlate polyester polyol, | | | | | |
| MW = 3500, OH number 27-34 | | | | | |
| (aromatic-aliphatic) | | | | | |
| Stabilizer | Irganox 1010 | 0.100 | 10000000 | | 0.0000 |
| optical brightener | Benetex OB | 0.010 | 10000000 | | 0.0000 |
| Hexanediol-adipate polyester polyol | 3500HA | 19.700 | 1750 | | 0.0113 |
| MW = 3500, OH number 27- | | | | | |
| 34(aliphatic) | | | | | |
| Ethylene gycol-adipic acid-iso- | Dynacoll 7130 | 10.000 | 1500 | | 0.0067 |
| terephlate polyester polyol, | | | | | |
| MW = 3500, OH number 27-34 | | | | | |
| (aromatic-aliphatic) | | | | | |
| monomer MDI | MLQ (Isocyanate) | 23.500 | 125 | | x |
| | | 71.3100 | NCO % | 8.65% | 0.0411 |

Eq. wt: = 485

### Example 7

### Adhesive

| | | | eq. wt. | % wt | OH | NCO |
|---|---|---|---|---|---|---|
| linear polyether polyol | LHT240 | 5.0000 | 235.6 | | 0.0212 | x |
| Caprolactone polyester | CAPA5600 | 6.9600 | 25000 | | 0.0003 | x |
| polyol (MW = 25000), | | | | | | |
| polyester polyol, OH | | | | | | |
| number 2-3 (aliphatic) | | | | | | |
| Ethylene gycol-adipic | 3500EAT | 13.0000 | 1750 | | 0.0074 | x |
| acid-Terephlate polyester | | | | | | |
| polyol, MW = 3500, OH | | | | | | |
| number 27-34 (aromatic- | | | | | | |
| aliphatic) | | | | | | |
| CaCO3 | Omycard 5FL | 10.0000 | 10000000 | | 0.0000 | x |
| same as Dynacoll 7380, I | 3500HD | 10.0000 | 1750 | | 0.0057 | x |
| Dodecandioic acid- | | | | | | |
| hexanediol polyester | | | | | | |
| polyol, MW = 3500, OH | | | | | | |
| nubmer 27-34 (aliphatic) | | | | | | |
| | Prepolymer | 55.0000 | 485 | | x | 0.1134 |
| | Ex. 6 | | | | | |
| activator 2,2′ morpholic | DMDEE | 0.0400 | 10000000 | | 0.0000 | x |
| | | 100.0000 | NCO % | 3.31% | | 0.1134 |

Actual viscosity at 285 F.: 26940 cP Actual NCO %: 3.20%
Roller coated, bonded honeycomb to galvanized steel, great adhesion
Coating weight 10.19 g/ft², open time is 1 min 15 sec, moderately strong and good transfer

### DISCUSSION OF THE FIGURES

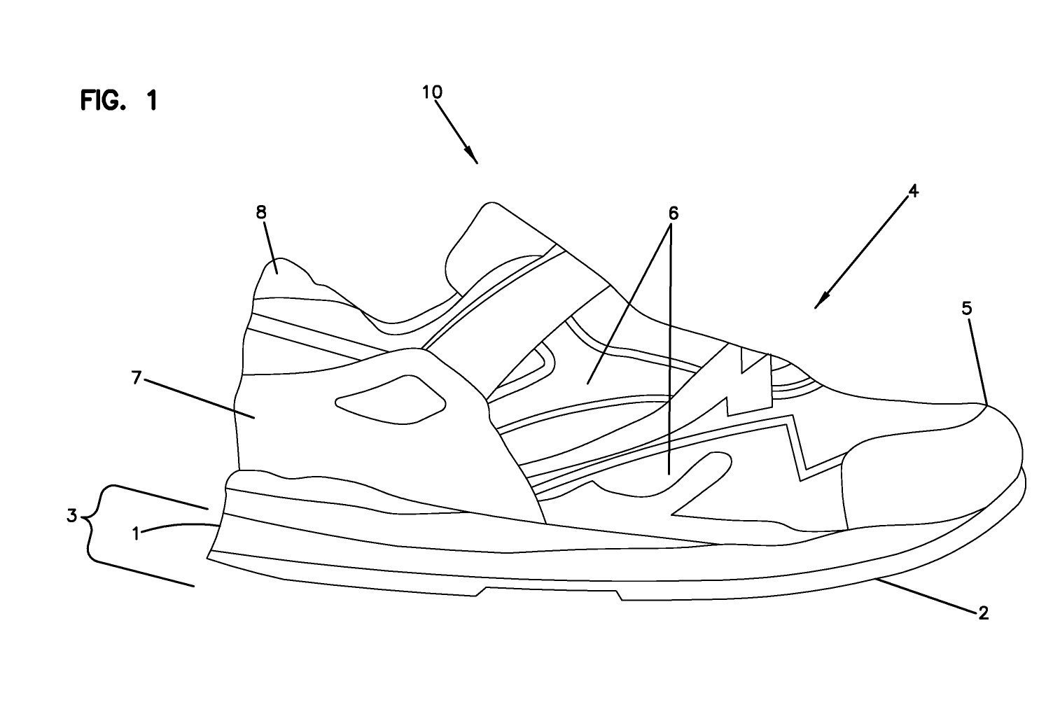

FIG. 1 shows a shoe components 10 assembly after final adhesive curing in which an upper is bonded to a mid sole and an outer sole suing the adhesives as disclosed herein. The shoe can be made with a preformed or one part sole. In FIG. 1 a sole assembly 1 is shown comprising an outer sole 2 and a mid sole 3. Bonded to the sole 1 is an upper 4. The upper compromises a toe 5, a heel 7 and additional upper components 6 including a heel tab 8 and other components obtaining a final fully assembled upper 4. In FIG. 1, the formed upper or portions thereof are bonded to the mid sole while the mid sole is bonded to the outer sole using the adhesive compositions as disclosed herein. In assembly, the upper 4 is positioned in a last. Once positioned the upper or important components thereof, are bonded to the mid sole using the adhesive disclosed. The adhesives as disclosed followed by bonding the outer sole 2 to the mid sole using the adhesives as disclosed.

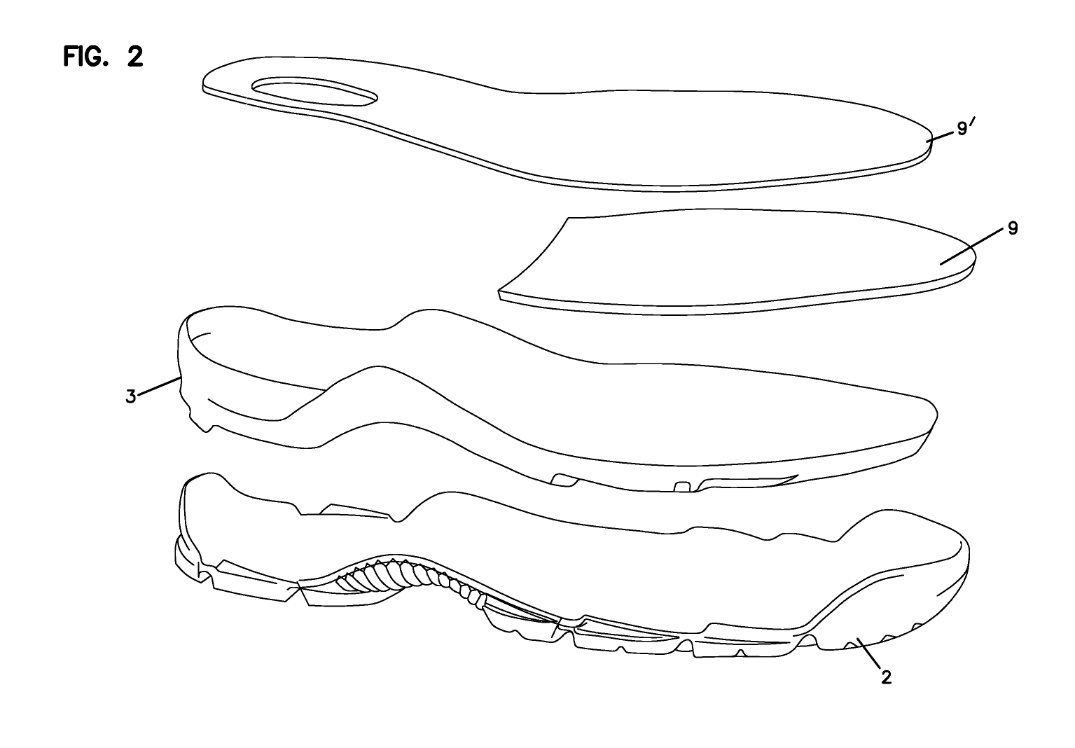

FIG. 2 shows an expanded or exploded view of the sole components 11 comprising of an outer sole 2, an inner sole 3 and optional components 9 or 9 prime that can be used to obtain further comfort support or performance from the athletic shoe material. In assembly, the adhesive is applied to adjacent surfaces of the mid sole 3 and the outer sole 2 to ensure a full bond of the mid sole to the outer sole. In the assembly of the shoe, the adhesive can be applied to either the mid sole 3 or the upper 4 for final bond strength.

TABLE 1

| | FIG. ELEMENTS |
|---|---|
| Shoe components | 10 |
| Sole components | 11 |
| Sole assembly | 1 |
| Outer sole | 2 |
| Mid-sole | 3 |
| Multi-part upper portion | 4 |
| Toe cap | 5 |
| Shoe components | 6 |
| Heel | 7 |
| Heel tab | 8 |
| Inner sole (partial) | 9 |
| Inner sole | 9′ |

The claims may suitably comprise, consist of, or consist essentially of, or be substantially free of any of the disclosed or recited elements. The structures and compositions illustratively disclosed herein can also be suitably practiced in the absence of any element which is not specifically disclosed herein. The various embodiments described above are provided by way of illustration only and should not be construed to limit the claims attached hereto. Various modifications and changes may be made without following the example embodiments and applications illustrated and described herein, and without departing from the true spirit and scope of the following claims

I claim:

1. An isocyanate prepolymer part useful in a two part urethane adhesive composition wherein a reactive polyol part is reacted with the isocyanate prepolymer part to form the adhesive bond, the isocyanate prepolymer comprising:
(i) a polyether polyol;
(ii) a polyester polyol; and
(iii) an isocyanate compound wherein there is about 5 to 40 weight percent of the polyether polyol, about 0 to 80 weight percent of a polyester polyol and about 20 to 50 weight percent of the isocyanate compound.

2. The prepolymer of claim 1 wherein the polyether polyol comprises a polyether diol.

3. The prepolymer of claim 1 wherein the polyether comprises a polyether triol.

4. The prepolymer of claim 1 wherein the polyether triol is manufactured using a starting compound having hydroxyl functionality of about 2-8.

5. The prepolymer of claim 1 wherein the polyether polyol comprises a polyethylene oxide polymer, a polypropylene oxide polymer or a copolymer comprising polyethylene oxide and polypropylene oxide.

6. The prepolymer of claim 1 wherein the polyester comprises aliphatic polyester.

7. The prepolymer of claim 1 wherein the polyester comprises aromatic polyester.

8. The prepolymer of claim 6 wherein the polyester comprises mixed aliphatic polyester comprising a blend of two aliphatic dicarboxylic acids having C₄₋₂₀ carbon atoms.

9. The prepolymer of claim 1 wherein the polyester comprises a mixed aliphatic and aromatic polyester.

10. The prepolymer of claim 7 wherein the polyester comprises aromatic polyester comprising terephthallic acid, isophthalic acids or mixtures thereof.

11. The prepolymer of claim 1 wherein the polyester polyol comprises a substantially crystalline polyester polyol.

12. The prepolymer of claim 6 wherein the polyester comprises polyester comprising an aliphatic dicarboxylic acid and a blend of hydroxy compounds comprising at least two of a diol, a triol, a tetrol or mixtures thereof.

13. The prepolymer of claim 7 wherein the polyester comprises an aromatic polyester made from an aromatic dicarboxylic acid and a hydroxy compound comprising a blend of hydroxy compounds comprising a diol, a triol, a tetrol or mixtures thereof.

14. The prepolymer of claim 1 wherein the polyether polyol comprises a polypropylene glycol.

15. The prepolymer of claim 1 wherein the polyether polyol comprises a polyethylene glycol.

16. The prepolymer of claim 1 wherein the polyester comprises a hydroxy compound comprising ethylene glycol, hexane diol, neopentyl glycol, pentaerythritol.

17. The prepolymer of claim 1 wherein the isocyanate compound comprises a monomeric diphenylmethane diisocyanate, or an oligomeric diphenylmethane diisocyanate.

18. The prepolymer of claim 1 wherein the prepolymer additional comprises an additive.

19. The prepolymer of claim 18 wherein the item comprises a stabilizer, an optical brightener, a filler, or mixtures thereof.

20. A two-part urethane adhesive comprising:
(i) A polyethylene oxide polymer selected from the polymers comprising polyethylene glycol, polypropylene glycol and mixtures thereof;
(ii) An aliphatic polyester resin;
(iii) A tackifing resin;
(iv) An isocyanate prepolymer composition,
the prepolymer comprising:
(a) a polyalkylene oxide compound comprising a polyethylene glycol,
polypropylene glycol or mixtures thereof;
(b) an aliphatic polyester resin, and
(c) an isocyanate compound.

21. The adhesive of claim 20 wherein at least one of the polyester resins comprises a blend of aliphatic polyesters comprising at least two of an aliphatic C₄₋₂₀ dicarboxylic acid.

22. The adhesive of claim 21 wherein the polyester comprises a hydroxy compound comprising ethylene glycol, hexanediol, neopentyl glycol, pentaerythritol or mixtures thereof.

23. The adhesive of claim 20 wherein the tackifier resin comprises a synthesitic atckifier such as Krystta; ex 3085.

24. The adhesive of claim 20 wherein the prepolymer, the polyalkylene oxide polymer comprises polypropylene glycol.

25. The adhesive of claim 21 wherein the polyester comprises a polyester comprising adipic acid, dodecanedioic acids or mixtures thereof.

26. The adhesive of claim 20 wherein the isocyanate compound comprises monomeric diphenylmethane diisocyanate or oligomeric diphenylmethane diisocyanate.

27. The adhesive of claim 20 wherein either one or both of the polyester resins comprise a crystalline polyester resin.

28. A two part urethane adhesive comprising a polyalkylene oxide poly ether triol;
(i) A vinyl polymer;
(ii) A tackifing resin;
(iii) An accelerator;
(iv) An isocyanate prepolymer,
the prepolymer comprising:
(a) a polyalkylene oxide polymer,
(b) a polyester comprising an aliphatic dicarboxylic acid and an aromatic dicarboxylic acid; and
(c) an isocyanate compound.

29. The adhesive of claim 28 wherein the vinyl polymer comprises an ethylene vinyl acetate polymer, an atactic polyalphaolefin polymer or mixtures thereof.

30. The adhesive of claim 28 wherein the tackifier comprises Krystta; ex 3085.

31. The adhesive of claim 28 wherein the accelerator comprises amine catalyst.

32. The adhesive of claim 28 wherein the isocyanate prepolymer, the polyalkylene oxide polymer comprises polyethylene glycol, polypropylene glycol or mixtures thereof.

33. The adhesive of claim 28 wherein the isocyanate prepolymer comprises a polyester comprising an aliphatic dicarboxylic acid comprising either adipic acid or dodecanedioic acid in combination with an aromatic dicarboxylic acid comprising terephthallic acid or isophthalic acid.

34. A two part urethane adhesive comprising a polyalkylene oxide polymer comprising polyethylene glycol, polypropylene glycol, or mixtures thereof;
(i) A polyester comprising a mixed aliphatic dicarboxylic acid having 4 to 20 carbon atoms;
(ii) A polyester comprising a mixed aliphatic and aromatic polyester comprising a C4-20 aliphatic dicarboxylic acid and an aromatic dicarboxylic acid comprising terephthallic acid, isophthalic acid or mixtures thereof;
(iii) A particulate solid filler;
(iv) An isocyanate activator compound;
(v) An isocyanate prepolymer,
the prepolymer comprising:
(a) a polyalkylene oxide polymer comprising polyethylene glycol, polypropylene glycol or a mixtures thereof;
(b) a polyester comprising a mixed aliphatic and aromatic polyester comprising a C₄₋₂₀ aliphatic dicarboxylic acid and an aromatic dicarboxylic acid comprising terephthallic acid, isophthalic acid or mixtures thereof; and
(c) an isocyanate compound.

35. An article comprising a first substrate and a second substrate with an adhesive joint therebetween, the joint comprising a cured urethane comprising the reaction product of:
(i) A polyethylene oxide polymer selected from the polymers comprising polyethylene glycol, polypropylene glycol and mixtures thereof;
(ii) An aliphatic polyester resin;
(iii) A tackifing resin;
(iv) An isocyanate prepolymer composition,
the prepolymer comprising:
(a) a polyalkylene oxide compound comprising a polyethylene glycol, polypropylene glycol or mixtures thereof;
(b) an aliphatic polyester resin, and
(c) an isocyanate compound.

36. The article of claim 35 wherein the cured urethane comprised the reaction product of:
(i) A vinyl polymer;
(ii) A tackifing resin;
(iii) An accelerator;
(iv) An isocyanate prepolymer,
the prepolymer comprising:
(a) a polyalkylene oxide polymer,
(b) a polyester comprising an aliphatic dicarboxylic acid and an aromatic dicarboxylic acid; and
(c) an isocyanate compound.
wherein the vinyl polymer comprises an ethylene vinyl acetate polymer, an atactic polyalphaolefin polymer or mixtures thereof.

37. The article of claim 35 wherein the cured urethane comprised the reaction product of:
(i) A polyester comprising a mixed aliphatic dicarboxylic acid having 4 to 20 carbon atoms;
(ii) A polyester comprising a mixed aliphatic and aromatic polyester comprising a C4-20 aliphatic dicarboxylic acid and an aromatic dicarboxylic acid comprising terephthallic acid, isophthalic acid or mixtures thereof;
(iii) A particulate solid filler;
(iv) An isocyanate activator compound;
(v) An isocyanate prepolymer,
the prepolymer comprising:
(a) a polyalkylene oxide polymer comprising polyethylene glycol, polypropylene glycol or a mixtures thereof;
(b) a polyester comprising a mixed aliphatic and aromatic polyester comprising a C₄₋₂₀ aliphatic dicarboxylic acid and an aromatic dicarboxylic acid comprising terephthallic acid, isophthalic acid or mixtures thereof; and
(c) an isocyanate compound.

38. A method of shoe manufacture comprising forming a shoe from an upper and a sole with an adhesive layer formed therebetween, the process comprising:
(i) applying an adhesive to the sole, the upper or both;
(ii) contacting the sole and the upper and curing the adhesive forming solid adhesive joint; and
(iii) removing any solid adhesive formed on the exterior of the joint.

39. The method of claim 38 wherein the adhesive comprises a:
(i) spray on layer;
(ii) layer applied by a doctor blade;
(iii) layer formed from a 3D printer; or
(iv) a layer formed from an adhesive film formed in the shape of the sole.

40. The method of claim 38 wherein the adhesive is removed by abrading the sold adhesive on the exterior of the joint.

41. The method of claim 40 wherein the abrasive is a flexible abrasive sheet.

42. The method of claim 40 wherein the abrasive is a particle blast.

43. The method of claim 42 wherein the particle blast is a dry ice particle blast.
